(19) United States
(12) Patent Application Publication
(10) Pub. No.: US 2024/0367421 A1
(43) Pub. Date: Nov. 7, 2024

(54) FILM FOR FLEXIBLE PACKAGING

(71) Applicant: SIG Combibloc Services AG, Neuhausen am Rheinfall (CH)

(72) Inventor: Teresa Bernal-Lara, Lincolnshire, IL (US)

(21) Appl. No.: 18/143,060

(22) Filed: May 3, 2023

(51) Int. Cl. B32B 27/08; B32B 7/03; B32B 7/12; B32B 27/18; B32B 27/32; B32B 27/34

(52) U.S. Cl. CPC B32B 27/08; B32B 7/03; B32B 7/12; B32B 27/18; B32B 27/32; B32B 27/34; B32B 2250/05; B32B 2250/24; B32B 2307/518; B32B 2307/7376; B32B 2553/00

(57) ABSTRACT

A film for flexible packaging having a cap layer, a core layer and a seal layer that are laminated together. The cap layer has a first side and a second side. The core layer has a first side and a second side. The second side of the cap layer is positioned to overlie the first side of the core layer and is laminated thereto. The seal layer has a first side and a second side. The second side of the core layer is positioned to overlie the first side of the seal layer and is laminated thereto. One of the cap layer and the core layer comprises a biaxially oriented polyamide. And, one of the cap layer and the seal layer comprises a blown film comprising polyethylene having a compatibilizer having a density of 95 g/cc.

### CROSS-REFERENCE TO RELATED APPLICATION

N/A

### BACKGROUND OF THE DISCLOSURE

### 1. Field of the Disclosure

The disclosure relates in general to flexible packaging, and more particularly, to a film for flexible packaging. Such flexible films disclosed herein have the robustness suitable for use in association with bag-in-box packaging and spouted pouch while having structures which are deemed recyclable with conventional recycling protocols and methods.

### 2. Background Art

The use of polymer based films in the production of flexible packaging is known in the art. Such flexible packaging, in some instances, forms the basis for bag-in-box packaging. In other instances, such flexible packaging comprises pouches having spouts extending therefrom. Such films often have required rugged specifications due to the strenuous shipping and handling environments experienced by such flexible packaging.

At the same time, there has been an increased focus on the recyclability of films. For some films used in certain applications, recycling has been problematic. For example, in certain applications, the combination of different polymers to form film structures suitable for difficult environments have rendered recycling difficult if not practically impossible. Finding film compositions which can be recycled while providing the necessary performance has been a challenge.

### SUMMARY OF THE DISCLOSURE

The disclosure is directed to a film for flexible packaging. The film comprises a cap layer, a core layer and a seal layer. The cap layer has a first side and a second side. The core layer has a first side and a second side. The second side of the cap layer is positioned to overlie the first side of the core layer and laminated thereto. The seal layer has a first side and a second side. The second side of the core layer is positioned to overlie the first side of the seal layer and laminated thereto. One of the cap layer and the core layer comprises a biaxially oriented polyamide. Additionally, one of the cap layer and the seal layer comprises a blown film comprising polyethylene having a compatibilizer having a density of 95 g/cc.

In some configurations, one of the cap layer or the seal layer comprises a three layer blown film coextrusion including a polyethylene layer on either side of a polyethylene and compatibilizer layer, and the other of the cap layer or the seal layer comprises a polyethylene.

In some configurations, the polyethylene and compatibilizer layer comprises 83% polyethylene and 17% compatibilizer by weight to achieve a compatibilizer level in the laminated structure of 2.9%.

In some configurations, the core layer comprises a polyamide.

In some configurations, the seal layer comprises a blown film comprising a polyethylene.

In some configurations, the cap layer comprises a blown film comprising a polyethylene.

In some configurations, the core layer comprises a polyamide.

In some configurations, the seal layer comprises a three layer blown film coextrusion including a polyethylene layer on either side of a polyethylene and compatibilizer layer.

In some configurations, the polyethylene and compatibilizer layer comprises 90% polyethylene and 10% compatibilizer by weight.

In some configurations, the cap layer has a thickness of 1.0 mil, the core layer has a thickness of 0.6 mil and the seal layer has a thickness of 1.8 mil.

In some configurations, the cap layer comprises a five layer blown film coextrusion including a central EVOH layer surrounded by tie layers on either side thereof, surrounded by polyethylene layers on either side thereof.

In some configurations, the core layer comprises a polyamide.

In some configurations, the seal layer comprises a three layer blown film coextrusion including a polyethylene layer on either side of a polyethylene and compatibilizer layer.

In some configurations, the polyethylene and compatibilizer layer comprises 78% polyethylene and 22% compatibilizer by weight.

In some configurations, the cap layer has a thickness of 1.7 mil, the core layer has a thickness of 0.4 mil and the seal layer has a thickness of 1.4 mil.

In some configurations, the cap layer comprises a polyamide.

In some configurations, the core layer comprises an adhesive.

In some configurations, the seal layer comprises a seven layer blown film coextrusion including a central EVOH layer surrounded by tie layers on either side thereof, surrounded by a polyethylene and compatibilizer layer surrounded by a polyethylene layer.

In some configurations, the polyethylene and compatibilizer layer comprises 93% polyethylene and 7% compatibilizer by weight.

In some configurations, the EVOH layer comprises 29 mol % EVOH.

In some configurations, the cap layer has a thickness of 0.48 mil, the core layer has a thickness of 0.1 mil, and the seal layer has a thickness of 5.50 mil.

In another aspect of the disclosure, the disclosure is directed to a flexible package for a bag-in-box packaging comprising a first film and a second film. Each film is formed from the film for flexible packaging as set forth herein. Additionally, the first film and the second film are positioned so the seal layer of the first film and the seal layer of the second film overlying abut each other. A seal seals the first film to the second film to form a cavity. In some such configurations, the film includes a configuration wherein the cap layer has a thickness of 1.0 mil, the core layer has a thickness of 0.6 mil and the seal layer has a thickness of 1.8 mil. In some such configurations, the cap layer has a thickness of 1.7 mil, the core layer has a thickness of 0.4 mil and the seal layer has a thickness of 1.4 mil.

In another aspect of the disclosure, the disclosure is directed to a flexible package forming a pouch comprising a first film and a second film. Each such film is formed from the film for flexible packaging set forth herein. Additionally, the first film and the second film are positioned so the seal layer of the first film and the seal layer of the second film overlying abut each other. A seal seals the first film to the second film to form a cavity. In some such configurations, the cap layer has a thickness of 0.48 mil, the core layer has a thickness of 0.1 mil, and the seal layer has a thickness of 5.50 mil.

### BRIEF DESCRIPTION OF THE DRAWINGS

The disclosure will now be described with reference to the drawings wherein:

FIG. 1 of the drawings is a schematic representation of a configuration of the film for flexible packaging of the present disclosure;

FIG. 2 of the drawing is a top plan view of a flexible package for use in association with bag-in-box packaging;

FIG. 3 of the drawings is a top plan view of a flexible package comprising a pouch having a spout;

FIG. 4 of the drawings is a schematic representation of a configuration of the film for flexible packaging of the present disclosure, suitable, for example, for use in the formation of a flexible bag for bag-in-box packaging, while not being limited thereto;

FIG. 5 of the drawings is a schematic representation of a configuration of the film for flexible packaging of the present disclosure, suitable, for example, for use in the formation of a flexible bag for bag-in-box packaging, while not being limited thereto;

FIG. 6 of the drawings is a schematic representation of a configuration of the film for flexible packaging of the present disclosure, suitable, for example, for use in the formation of a flexible bag for bag-in-box packaging, while not being limited thereto and

FIG. 7 of the drawings is a schematic representation of a configuration of the film for flexible packaging of the present disclosure, suitable, for example, for use in the formation of a pouch, while not being limited thereto.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

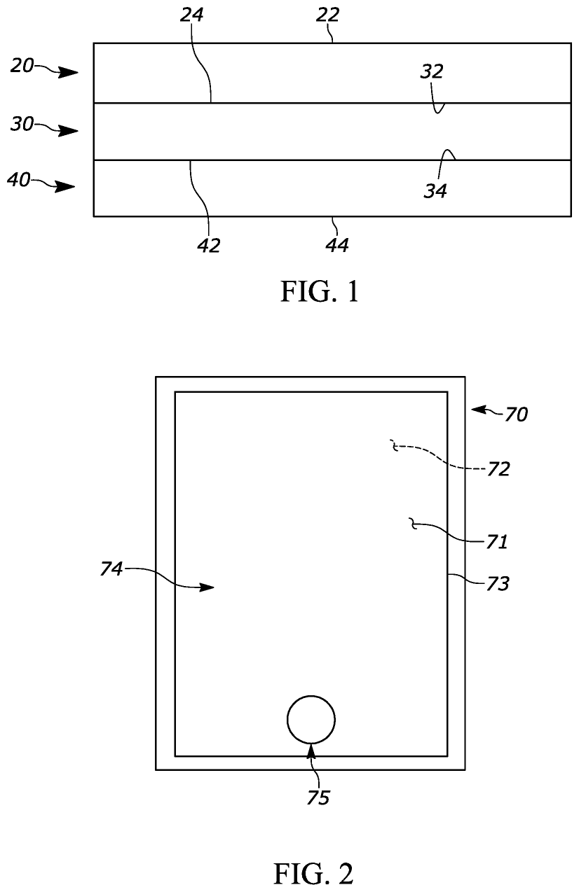

Referring now to the drawings and in particular to FIG. 1, the film for flexible packaging 10 is shown as comprising cap layer 20, core layer 30 and seal layer 40, wherein the layers are laminated to each other. The film can be utilized to form flexible bags and pouches. For example, in some configurations the film can be used to form a flexible bag 70 that can be used for bag-in-box applications, such as is shown in FIG. 2. Such a flexible bag has a first film 71 and a second film 72 wherein the seal layers of each of the first film and the second film overly each other, and are attached together with seals 73 to form a cavity 74.

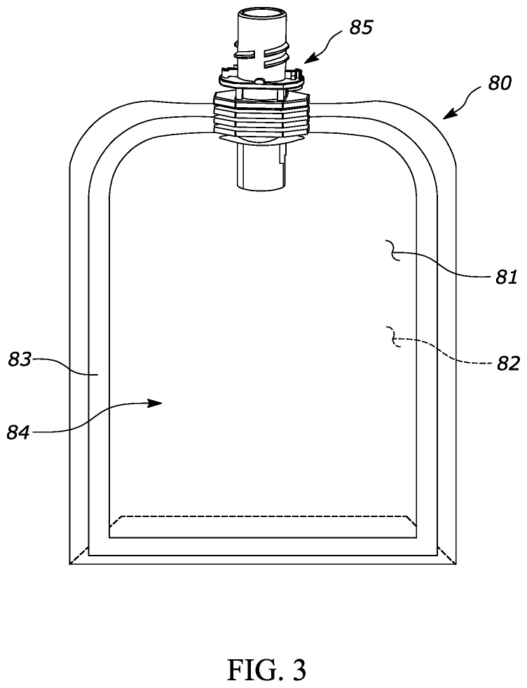

In other configurations, the film can be used to form a pouch, such as the pouch 80 that is shown in FIG. 3. In such a configuration, in a similar manner, a first film 81 and a second film 82 are positioned to overlie each other (with additional gussets therebetween as desired) with the seal layers overly each other and are attached together with seals 83 to form a cavity 84.

In any such configurations, the seal layers of the films form the inner layers, with the cap layers forming the outer sides and can be sealed together through the formation of seals (i.e., through RF, ultrasonic, thermal welding, among other techniques). Spouts 75, 85 may be extended through the film(s) or may be sandwiched between the films and sealed by the seals.

The flexible bags formed from films of the present disclosure may be utilized to retain, typically, a flowable material in a substantially fluid tight configuration. Such flowable material may comprise foodstuffs, such as syrups, oils, purees, beverages, dressings, condiments, liquids, pastes, sauces, as well as suspended solids, and solids that may include granular material. Of course, the foregoing are merely examples of flowable material which may be positioned within a flexible bag made from the films disclosed is not to be deemed limiting, but are to be utilized solely as examples.

Returning now to FIG. 1, cap layer 20 includes a first side 22 and a second side 24 opposite the first side 22. The core layer 30 includes a first side 32 and a second side 34 opposite the first side 32. The seal layer 40 includes a first side 42 and a second side 44 opposite the first side 42. As set forth above, the layers are laminated together.

In greater detail, the second side 24 of the cap layer 20 is laminated to the first side 32 of the core layer 30. The second side 34 of the core layer 30 is laminated to the first side 42 of the seal layer 40. In the configurations set forth herein, the lamination may be through adhesive, extrusion or thermal lamination, among others.

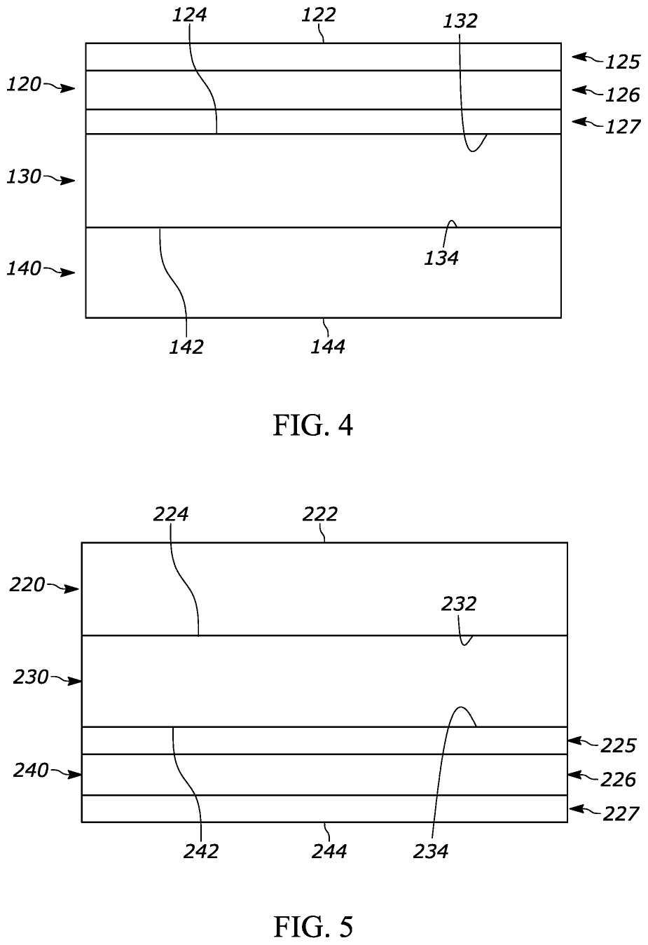

In one configuration shown in FIG. 4, which exhibits sufficient robustness suitable for use in association with bag-in-box applications, the cap layer 120, core layer 130 and seal layer 140 are shown. The different components will have the same numbering shown in FIG. 1, augmented by a hundred. It is contemplated that the overall thickness of the laminate is between 2.4 mil and 4.9 mil. For such a bag-in-box application, it will be understood that such flexible bags may weigh on the order of, for example, and without limitation, approximately 23 kg or the like when filled. Such filled flexible bags are often slid on inclined surfaces into outer boxes, dropped into outer boxes, or otherwise handled rather aggressively.

In the configuration in FIG. 4, the cap layer 120 comprises a three layer co-extruded blown film having a thickness of approximately 1.0 mil, while thickness between 0.7 mil and 1.3 mil are contemplated. The co-extruded blown film comprises a first layer 125 comprising a polyethylene, a second layer 126 comprising a polyethylene mixed with a compatibilizer, and a third layer 127 comprising a polyethylene. The polyethylene first and third layers 125, 127 comprise 70% EVA and 30% LLDPE. The second layer comprises approximately 83% PE and 17% compatibilizer by weight, to achieve a compatibilizer level in the film 10 of 2.9% by weight. The amount of compatibilizer in the second layer depends on the layer ratios selected for the cap layer 120. In the configuration shown, the selected layer ratio is 20/60/20, for layers 125/126/127, respectively. It is contemplated that the layer ratios in the cap layer may be adjusted further while maintaining the level of the compatibilizer by weight in the film 10, for this particular configuration, that will be 2.9%. It is contemplated that compatibilizer levels by weight in the film 10 are between approximately 1% and 6%. In the configuration shown, the compatibilizer has a density of 0.95 g/cc. It is contemplated that the range of the density of the compatibilizer is between 0.87 g/cc and 0.95 g/cc.

In the configuration shown, the core layer 130 comprises a Polyamide (PA) which is biaxially oriented nylon. In the configuration shown, the PA has a thickness of approximately 0.60 mil, while thicknesses of between 0.32 mil and 1.0 mil are contemplated. Further, in the configuration shown, the seal layer 140 comprises a polyethylene having a thickness of 1.8 mil, while thicknesses of between 1.4 mil and 2.6 mil are contemplated. The seal layer 140 comprises a blown layer of film.

In the configuration in FIG. 5, the cap layer 220 comprises a polyethylene having a thickness of approximately 1.0 mil, while thicknesses between 0.7 mil and 1.3 mil are contemplated. The cap layer 220 comprises a blown layer of film.

In the configuration shown, the core layer 230 comprises a Polyamide (PA) which is biaxially oriented nylon. In the configuration shown, the PA has a thickness of approximately 0.60 mil, while thicknesses of between 0.32 mil and 1.0 mil are contemplated.

Further, in the configuration shown, the seal layer 240 comprises a three layer co-extruded blown film having a thickness of 1.8 mil, while thickness between 1.4 mil and 2.6 mil are contemplated. The co-extruded blown film comprises a first layer 225 comprising a polyethylene, a second layer 226 comprising a polyethylene mixed with a compatibilizer, and a third layer 227 comprising a polyethylene. The polyethylene first and third layers 225, 227 comprise 70% EVA and 30% LLDPE. The second layer comprises approximately 90% PE and 10% compatibilizer by weight, to achieve a compatibilizer level in the film of 3.1% by weight. The amount of compatibilizer in the second layer depends on the layer ratios selected for the seal layer 140. In this configuration, the selected layer ratio is 20/60/20, for layers 225/242/227, respectively. The layer ratios in the seal layer 240 may be adjusted as long as the level of the compatibilizer by weight in the film remains the same, which, in the configuration shown is 3.1%. It is contemplated that compatibilizer levels by weight in the film are between approximately 1% and 6%. It is contemplated that in a film in accordance with this disclosure, the compatibilizer has a density of 0.95 g/cc. It is further contemplated that the compatibilizer density may range between 0.87 g/cc and 0.95 g/cc.

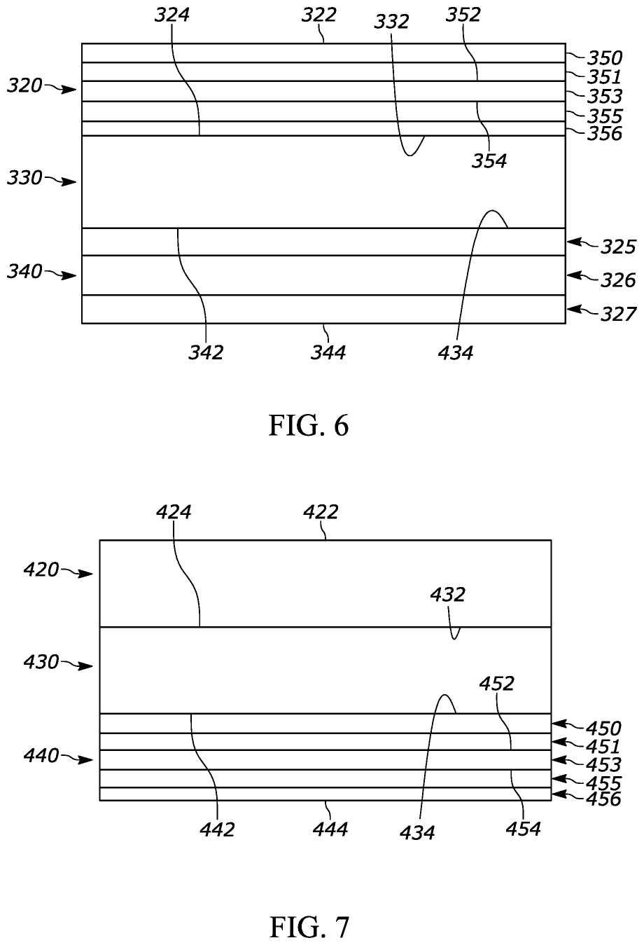

In the configuration in FIG. 6, the cap layer 320 comprises a five layer coextrusion that has a thickness of approximately 1.7 mil, while thicknesses of between 1.2 mil and 2.2 mil are contemplated. Additionally, the cap layer comprises a blown layer. The five layer coextrusion includes layers 350, 352, 353, 354, and 356. The layers 350, 356 comprises a polyethylene, and which has a thickness of between 0.25 mil and 0.88 mil.

The tie layers 352, 354 comprise a thickness of between 0.1 mil and 0.4 mil, and comprise a anhydride modified LLDPE. The EVOH layer 353 comprises a 29 mol % EVOH layer having a thickness of between 0.1 mil and 0.5 mil.

In the configuration shown, the core layer 330 comprises a Polyamide (PA) which is biaxially oriented nylon. In the configuration shown, the PA has a thickness of approximately 0.40 mil, while thicknesses of between 0.32 mil and 0.6 mil are contemplated.

Further, in the configuration shown in FIG. 6, the seal layer 340 comprises a three layer co-extruded blown film having a thickness of 1.4 mil, while thickness between 1.1 mil and 1.7 mil are contemplated. The co-extruded blown film comprises a first layer 325 comprising a polyethylene, a second layer 326 comprising a polyethylene mixed with a compatibilizer, and a third layer 327 comprising a polyethylene. The polyethylene first layer, 325, comprises 65% mPE and 35% EVA. The third layer, 327, comprises LLDPE with a density of 0.921 g/cc and mPE with a density of 0.911 g/cc. The second layer comprises approximately 78% mPE and 22% compatibilizer by weight, to achieve a compatibilizer level in the film of 4.9% by weight. The amount of compatibilizer in the second layer depends on the layer ratios selected for the seal layer. In the configuration shown, the selected layer ratio is 20/60/20, for layers 325/326/327, respectively. It is contemplated that the layer ratios in the seal layer may be varied so that compatibilizer by weight in the film is 4.9%. It is further contemplated that compatibilizer levels by weight in the film are between approximately 2% and 7%. For the configuration set forth, the compatibilizer has a density of 0.95 g/cc. It is further contemplated that the compatibilizer density is between 0.87 g/cc and 0.95 g/cc.

For the film configurations shown in FIGS. 4, 5 and 6, it will be understood that the cap layer 120/220/320, the core layer 130/230/330 and the seal layer 140/240/340 are thermally laminated together, while other laminating processes are likewise contemplated in other configurations. It will further be understood that the flexible bag formed from such a film will have the cap layer as the outer layer of the flexible bag, and the seal layer as the inside layer of the flexible bag, wherein the seal layer of facing films can be formed through any number of different methods known in the art, at least some of which are set forth above.

In another configuration of a film 410 shown in FIG. 7, which is suitable for the formation of pouches having, for example, fin seal spouts formed at a seal between facing films (while not being limited thereto), the cap layer 420, core layer 430 and seal layer 440 are shown. The different components will have the same numbering shown in FIG. 1, augmented by four hundred.

In such a configuration, the cap layer 420 comprises PA, and in particular, a biaxially oriented nylon having a thickness of approximately 0.48 mil, while thicknesses of between 0.32 mil and 0.6 mil are contemplated.

The core layer 430 of the configuration shown in FIG. 7 comprises an adhesive that can be roller applied or otherwise applied. In the configuration shown, the adhesive comprises a solventless adhesive which, when rolled has a thickness of approximately 0.04 mil through 0.12 mil, and more preferably approximately 0.10 mil.

The seal layer 440 is shown as comprising a seven layer coextrusion that has a thickness of approximately 5.50 mil, while thicknesses of between 2.0 mil and 6.0 mil are contemplated. Additionally, the seal layer comprises a blown layer. The seven layer coextrusion includes layers 450, 451, 452, 453, 454, 455, and 456. The layers 450, 456 comprises a polyethylene, and which has a thickness of between 0.4 mil and 1.3 mil. The layers 451, 455 comprise a polyethylene and compatibilizer, having a thickness of between 0.5 mil and 1.4 mil. In the configuration shown, the layers 451, 455 comprise approximately 93% polyethylene and 7% compatibilizer by weight, to achieve a compatibilizer level in the film of 2.8% by weight. The amount of compatibilizer in layers 451, 455 depends on the layer ratios selected for the film. In this configuration, the selected layer ratio is 22/23/4/4/4/23/22, for layers 450/451/452/453/454/455/456, respectively. The layer ratios in the seal layer may be adjusted as long as the level of the compatibilizer by weight in the film remains, for the configuration shown, at the same 2.8%. It is contemplated that compatibilizer levels by weight in the film are between approximately 1% and 3%. In the configuration shown, the compatibilizer has a density of 0.95 g/cc. It is contemplated that the compatibilizer density may be between 0.87 g/cc and 0.95 g/cc. The polyethylene of the layers 450, 451, 455 and 456 comprise LLDPE with a density of 0.921 g/cc and mPE with a density of 0.911 g/cc.

The tie layers 452, 454 comprise a thickness of between 0.1 mil and 0.4 mil, and comprise a anhydride modified LLDPE. The EVOH layer 453 comprises a 29 mol % EVOH layer having a thickness of between 0.1 mil and 0.5 mil.

Advantageously, the utilization of biaxial polyamide layers combined with blown PE based layers, and the use of a compatibilizer as shown, yields films that have the robustness for the intended applications while providing for recyclability.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A film for flexible packaging, the film comprising:
a cap layer having a first side and a second side;
a core layer having a first side and a second side, the second side of the cap layer being positioned to overlie the first side of the core layer and laminated thereto; and
a seal layer having a first side and a second side, the second side of the core layer being positioned to overlie the first side of the seal layer and laminated thereto;
wherein one of the cap layer and the core layer comprises a biaxially oriented polyamide;
wherein one of the cap layer and the seal layer comprises a blown film comprising polyethylene having a compatibilizer having a density of 95 g/cc.

2. The film for flexible packaging of claim 1 wherein one of the cap layer or the seal layer comprises a three layer blown film coextrusion including a polyethylene layer on either side of a polyethylene and compatibilizer layer, and the other of the cap layer or the seal layer comprises a polyethylene.

3. The film for flexible packaging of claim 2 wherein the compatibilizer comprises between 1% to 6% by weight of the film.

4. The film for flexible packaging of claim 2 wherein the core layer comprises a polyamide.

5. The film for flexible packaging of claim 4 wherein the core layer has a thickness of between 0.32 mil and 1.0 mil.

6. The film for flexible packaging of claim 4 wherein the seal layer comprises a blown film.

7. The film for flexible packaging of claim 6 wherein the cap layer comprises a blown film.

8. The film for flexible packaging of claim 1 wherein the cap layer comprises a seven layer blown film coextrusion including a central EVOH layer surrounded by tie layers on either side thereof, surrounded by a polyethylene and compatibilizer layer surrounded by a polyethylene layer.

9. The film for flexible packaging of claim 8 wherein the EVOH layer comprises EVOH in the range of 27 to 32 mol % EVOH.

10. The film for flexible packaging of claim 8 wherein the seal layer comprises a three layer blown film coextrusion including a polyethylene layer on either side of a polyethylene and compatibilizer layer.

11. The film for flexible packaging of claim 10 wherein the core layer comprises a polyamide.

12. The film for flexible packaging of claim 11 wherein the core layer has a thickness of between 0.32 mil and 0.6 mil.

13. The film for flexible packaging of claim 10 wherein the compatibilizer comprises between 2% and 7% by weight of the film.

14. The film for flexible packaging of claim 1 wherein the cap layer comprises a polyamide, and the core layer comprises an adhesive.

15. The film for flexible packaging of claim 14 wherein the seal layer comprises a seven layer blown film coextrusion including a central EVOH layer surrounded by tie layers on either side thereof, surrounded by a polyethylene and compatibilizer layer surrounded by a polyethylene layer.

16. The film for flexible packaging of claim 15 wherein the EVOH layer comprises EVOH in the range of 27 to 32 mol % EVOH.

17. The film for flexible packaging of claim 15 wherein the compatibilizer comprises between 1% and 3% by weight of the film.

18. The film for flexible packaging of claim 15 wherein the cap layer has a thickness of between 0.32 mil and 0.6 mil.

19. A flexible package for a bag-in-box packaging comprising:
a first film and a second film, each formed from the film for flexible packaging of claim 7, wherein the first film and the second film are positioned so the seal layer of the first film and the seal layer of the second film overlying abut each other;
a seal sealing the first film to the second film to form a cavity.

20. A flexible package for a bag-in-box packaging comprising:
a first film and a second film, each formed from the film for flexible packaging of claim 11, wherein the first film and the second film are positioned so the seal layer of the first film and the seal layer of the second film overlying abut each other;
a seal sealing the first film to the second film to form a cavity.

21. A flexible package forming a pouch comprising:
a first film and a second film, each formed from the film for flexible packaging of claim 15, wherein the first film and the second film are positioned so the seal layer of the first film and the seal layer of the second film overlying abut each other;
a seal sealing the first film to the second film to form a cavity
